(19) United States
(12) Patent Application Publication
(10) Pub. No.: US 2023/0177581 A1
(43) Pub. Date: Jun. 8, 2023

(54) PRODUCT METADATA SUGGESTION USING EMBEDDINGS

(71) Applicant: Accenture Global Solutions Limited, Dublin (IE)

(72) Inventors: Hongyi Ren, Sunnyvale, CA (US); Sujeong Cha, Long Island City, NY (US); Lan Guan, Johns Creek, GA (US); Jayashree Subrahmonia, San Jose, CA (US); Anwitha Paruchuri, San Jose, CA (US); Sukryool Kang, Dublin, CA (US); Guanglei Xiong, Pleasanton, CA (US); Heather M. Murphy, Cary, NC (US)

(21) Appl. No.: 17/457,539

(22) Filed: Dec. 3, 2021

(51) Int. Cl. G06Q 30/06

(52) U.S. Cl. CPC G06Q 30/0631

(57) ABSTRACT

Implementations are directed to receiving a product profile comprising an image of a product and a text description of the product; encoding the image and the text description of the product to obtain an image vector and a textual vector in a latent space; wherein the encoding comprises encoding the image and the text description using one or more encoders, each encoder corresponding to a respective data type; concatenating the image vector and the textual vector to provide a total latent vector; processing the total latent vector through a neural recommendation model to generate a score for each feature included in a plurality of features, wherein the score for a feature indicates a likelihood of the feature being included as a feature of the product for product development; and generating a recommendation comprising a set of candidate features for the product based on the score of each feature.

### BACKGROUND

Enterprises provide different goods and/or services to customers. The products and/or services can have various features or functions. It is important to include the right features that are preferred and most demanded by customers in a product. However, it is challenging to identify the right features for a product. This is especially difficult for small companies that might have limited resources to collect customer feedback data on their products. Even for large companies that can afford to collect enough feedback on their products' features, it is difficult to predict consumer feedback on undeveloped features. Therefore, there is a need for technologies that can identify useful product features for different products at a low cost. Such technologies can help both small and large businesses to improve existing products and/or develop new products.

To this end, recommendation systems have been developed. Some traditional recommendation systems are provided as machine learning (ML) systems to provide one or more recommendations on user preferences. However, such traditional recommendation systems suffer from technical disadvantages. First, such traditional recommendation systems are limited in terms of input. For example, the input includes interaction history between users and products, which usually involves one-hot encoding representations for user identifier (ID) and product ID, and the rating between user-product pairs. The information included in such input is limited. For example, an image and/or a text description of the products may contain richer information about the products. However, traditional recommendation systems accept fixed and pre-determined types of inputs, losing the flexibility to utilize both image and text information about the products. Second, such traditional recommendation systems are limited in terms of output, because they are built to recommend a list of products to a user based on interaction history. In other words, the traditional recommendation systems can only recommend a product to a user, but cannot predict features of a product that might be preferred by users. Thus, some traditional recommendation systems have not been used to develop or enhance products with desirable features.

As a result, the prediction results generated by traditional recommendation systems may be less accurate and applicable to limited application scenarios. Traditional recommendation systems are incapable of or have limited capabilities in providing recommendations for product development or product enhancement.

### SUMMARY

Implementations of the present disclosure are generally directed to a recommendation system that enables product feature recommendation for both existing products and new-to-market products. More particularly, implementations of the present disclosure are directed to a recommendation system that enables web crawling, executes machine learning (ML) model training, and builds ML models for any type of input of product profile. The recommendation system of the present disclosure generates recommendations of candidate product features, which are most preferred and desired by customers in both business-to-business (B2B) and business-to-consumer (B2C) contexts.

In some implementations, actions include receiving a product profile comprising an image of a product and a text description of the product; encoding the image and the text description of the product to obtain an image vector and a textual vector in a latent space; wherein the encoding comprises encoding the image and the text description using one or more encoders, each encoder corresponding to a respective data type, data types comprising image data, textual data, and feature data; concatenating the image vector and the textual vector to provide a total latent vector; processing the total latent vector through a neural recommendation model to generate a score for each feature included in a plurality of features, wherein the score for a feature indicates a likelihood of the feature being included as a feature of the product for product development; and generating a recommendation comprising a set of candidate features for the product based on the score of each feature. Other implementations of this aspect include corresponding systems, apparatus, and computer programs, configured to perform the actions of the methods, encoded on computer storage devices.

These and other implementations can each optionally include one or more of the following features: determining a similarity between a first product and a second product based on i) a first image vector, a first textual vector, and a first categorical vector of the first product and ii) a second image vector, a second textual vector, and a second categorical vector of the second product; determining the similarity based on at least one of a cosine similarity and a Euclidean distance; ranking the set of candidate features for the product based on the score of each feature; the one or more encoders include an image encoder for encoding the image, a text encoder for encoding the text description, and a categorical encoder for encoding the feature data; the image encoder is a pre-trained model includes Residual Networks (ResNet); the text encoder includes a Doc2Vec model; the categorical encoder includes a one-hot encoding algorithm; the neural recommendation model is trained and periodically updated based on data from a web crawling engine, wherein the neural recommendation model is trained based on at least one of images, text descriptions and feature data of products; the plurality of features are extracted from data from a web crawling engine.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an example system that can execute implementations of the present disclosure.

FIG. 2 depicts an example conceptual architecture including a recommendation system in accordance with implementations of the present disclosure.

FIG. 3 depicts a representation of a recommendation workflow in accordance with implementations of the present disclosure.

FIG. 4 depicts a representation of a recommendation structure during the training process, in accordance with implementations of the present disclosure.

FIG. 5 depicts an example of a product profile to be evaluated in accordance with implementations of the present disclosure.

FIG. 6A depicts an example of recommendation results for an existing product in accordance with implementations of the present disclosure.

FIG. 6B depicts an example of recommendation results for a new-to-market product in accordance with implementations of the present disclosure.

FIG. 7 depicts an example process of predicting features for a product in accordance with implementations of the present disclosure.

Like reference numbers and designations in the various drawings indicate like elements.

### DETAILED DESCRIPTION

Implementations of the present disclosure are generally directed to a recommendation system that enables product feature recommendation for both existing products and new-to-market products. More particularly, implementations of the present disclosure are directed to a recommendation system that enables web crawling, executes machine learning (ML) model training and builds ML models for any type of input of product profile. The recommendation system of the present disclosure generates recommendations of candidate product features, which are most preferred and desired by customers in both business-to-business (B2B) and business-to-consumer (B2C) contexts.

In some implementations, actions include receiving a product profile comprising an image of a product and a text description of the product; encoding the image and the text description of the product to obtain an image vector and a textual vector in a latent space; wherein the encoding comprises encoding the image and the text description using one or more encoders, each encoder corresponding to a respective data type, data types comprising image data, textual data, and feature data; concatenating the image vector and the textual vector to provide a total latent vector; processing the total latent vector through a neural recommendation model to generate a score for each feature included in a plurality of features, wherein the score for a feature indicates a likelihood of the feature being included as a feature of the product for product development; and generating a recommendation comprising a set of candidate features for the product based on the score of each feature.

To provide context for implementations of the present disclosure, and as introduced above, enterprises provide different goods and/or services to customers. It is important to include the right features that are preferred and most demanded by customers in a product. There is a need for technologies that can identify useful product features for different products at a low cost. However, traditional recommendation systems suffer from technical disadvantages. First, traditional recommendation systems are limited in terms of input. The input in traditional recommendation systems is interaction history between users and products. An image and/or a text description of the products may contain richer information about the products, which are not considered in the traditional recommendation systems. Second, traditional recommendation systems are limited in terms of output, because they are built to suggest a list of products to a user based on interaction history, but cannot predict the features of a product that are preferred by users. As a result, the prediction results generated by traditional recommendation systems may be less accurate and applicable to less applications. Traditional recommendation systems are incapable of or have limited capabilities in providing recommendations for product development or product enhancement.

In view of this, implementations of the present disclosure are directed to a recommendation system that accepts any appropriate type of input and enables product feature recommendation for both existing products and new-to market products. As described in further detail herein, the recommendation system of the present disclosure can take any appropriate type of input simultaneously, including images, text descriptions, and categorical features. By utilizing such input information, the recommendation system of the present disclosure captures rich semantics of product profiles to boost recommendation quality (e.g., particularly in the case of new-to-market products, for which little to no product feature data and feedback data is available). The recommendation system of the present disclosure can not only suggest an item to a user, but also estimate the market expectation for a feature of a product, which is recommendation data in a finer scale. The recommendation system of the present disclosure can not only make recommendation on already existing features, but also identify and recommend features that are not already existing in products.

Furthermore, the recommendation system of the present disclosure can provide recommendations for both existing products and new-to-market products. For example, the recommendation system of the present disclosure can predict preferred candidate features for existing products. Such recommended features for existing product are associated with a score indicating a priority of the corresponding feature relative to other features. This can help enterprises or product development teams organize the development process more efficiently, and invest resources in developing features with higher priorities first. The recommendation system of the present disclosure can also predict candidate features for new-to-market products. Such recommended features for new-to-market products can help the product development team deliver the desirable features along the respective priorities and grow their business.

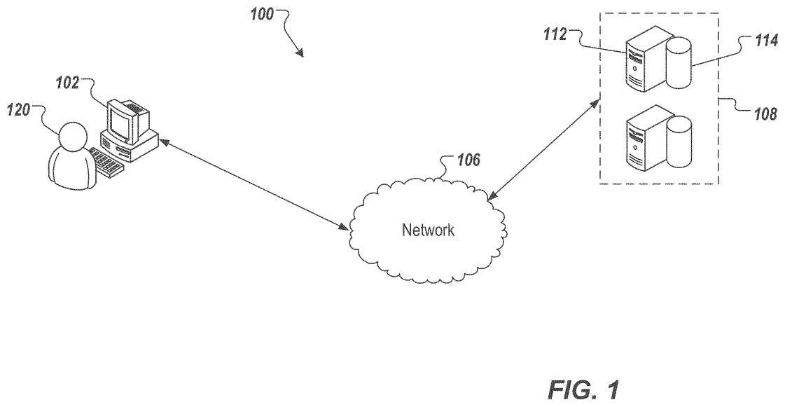

FIG. 1 depicts an example system 100 that can execute implementations of the present disclosure. The example system 100 includes a computing device 102, a back-end system 108, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communication link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the back-end system 108 includes at least one server system 112, and data store 114 (e.g., database). In some examples, the at least one server system 112 hosts one or more computer-implemented services that users can interact with using computing devices. For example, the server system 112 can host a recommendation system in accordance with implementations of the present disclosure.

Implementations of the present disclosure are described in further detail herein with reference to an example use case that includes recommending candidate features for products, including existing products and new-to-market products. For example, the recommendation system of the present disclosure can be used to predict or recommend a set of candidate features for different products that are most likely to be preferred by customers/users. It is contemplated, however, that implementations of the present disclosure can be applied in any appropriate use case.

More specifically, the back-end system 108 can receive a request from the computing device 102 over the network 106. The request can include a product profile, such as product image, product text description, and product feature data. In some examples, the product profile may not include a full set of product images, product text description, and product feature data. For example, for new-to-market products, the product feature data may not be available. In another example, a product image or product text description is not available. The recommendation system of the present disclosure can generate recommendations based on part or a subset of the product profile.

In some examples, the request is issued by a user 120, such as a member in the product development team, or an employee of the enterprise providing the product. After receiving the request, the back-end system 108 can process the request through a recommendation system hosted on the server system 112. As described in further detail herein, the recommendation system is configured to process the product profile to obtain latent vectors that represent the product image, text description, and feature data. The latent vectors are feed into a neural recommendation model to generate a recommendation including a set of candidate features for the product. The back-end system 108 can return the generated candidate features to the computing device 102 over the network 106.

In some examples, the server system 112 can store the obtained latent vectors in the data store 114. The server system 112 can also retrieve the latent vectors from the data store 114. The data store 114 can include any other information necessary for performing the functions described herein. For example, the data store 114 can store product profiles, including product images, product text description, and product feature data, the latent vectors of each data type, and the like.

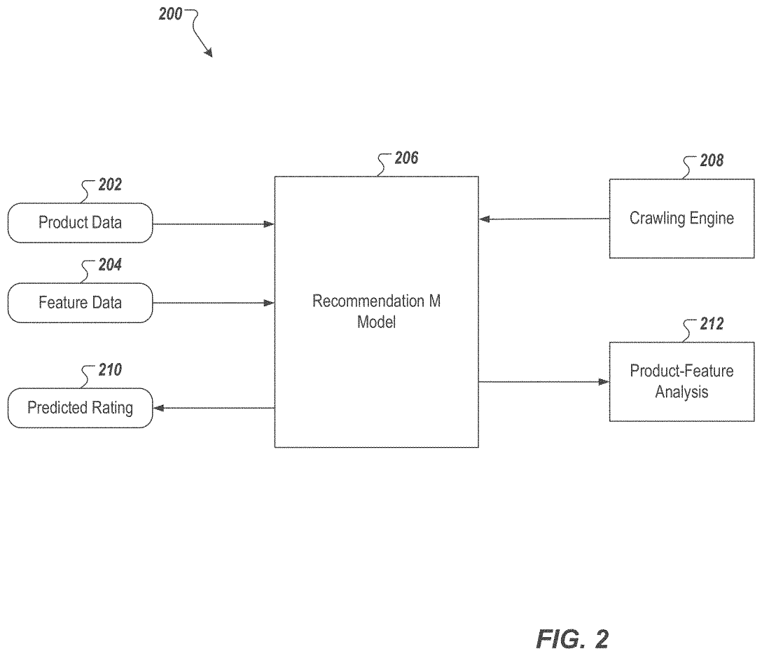

FIG. 2 depicts an example conceptual architecture 200 including a recommendation system in accordance with implementations of the present disclosure. In FIG. 2, the example conceptual architecture 200 includes a recommendation module 206 that takes product data 202 and feature data 204 of one or more products as input and generates predicted ratings 210 for the one or more products. The recommendation module 206 can include a neural recommendation model this is trained based on web crawled data from a crawling engine 208. The recommendation module 206 can also generate vectors in product latent space and feature latent space, which can be used to perform product-feature analysis 212.

The product data 202 of a product can include a product image and text description, which are processed by the recommendation module 206 using flatten layers (FL) to map into a latent space. For example, an image vector and a textual vector in the latent space are obtained. The latent vectors can be stored in a product database. The feature data 204 can be processed by the recommendation module 206 using flatten layers (FL) to map into the latent space. For example, a categorical vector, such as a one-hot vector in the latent space is obtained. The latent vectors can be stored in a feature database.

The crawling engine 208 collects feedback, including feedback data of features in different products, from one or more data sources, such as the Internet. The recommendation module 206 uses the web crawled data to train a neural recommendation model that takes the latent vectors as input and predicts a rating score for each product-feature pair. The neural recommendation system can predict the rating scores by neural collaborative filtering. In some implementations, the crawling engine 208 can be part of the recommendation system hosted in the back-end system 108 in FIG. 1. Alternatively, the crawling engine 208 can be a separate server system, such as a third-party server, that is not located in the back-end system 108 in FIG. 1. In this case, the web crawler can interact with the recommendation system over a network.

The predicted ratings 210 can be prediction results or recommendation results including predicted rating score for each product-feature pair. With the predictions, product development teams can decide which features to develop in the next step.

During the product-feature analysis 212, the latent vectors of representations of products in the latent space can be retrieved from the product database, the latent vectors of representations of features in the latent space can be retrieved from the feature database. Similarities of products or features can be represented by distance in the latent space. As a result, similar products and features can be searched using the latent space database.

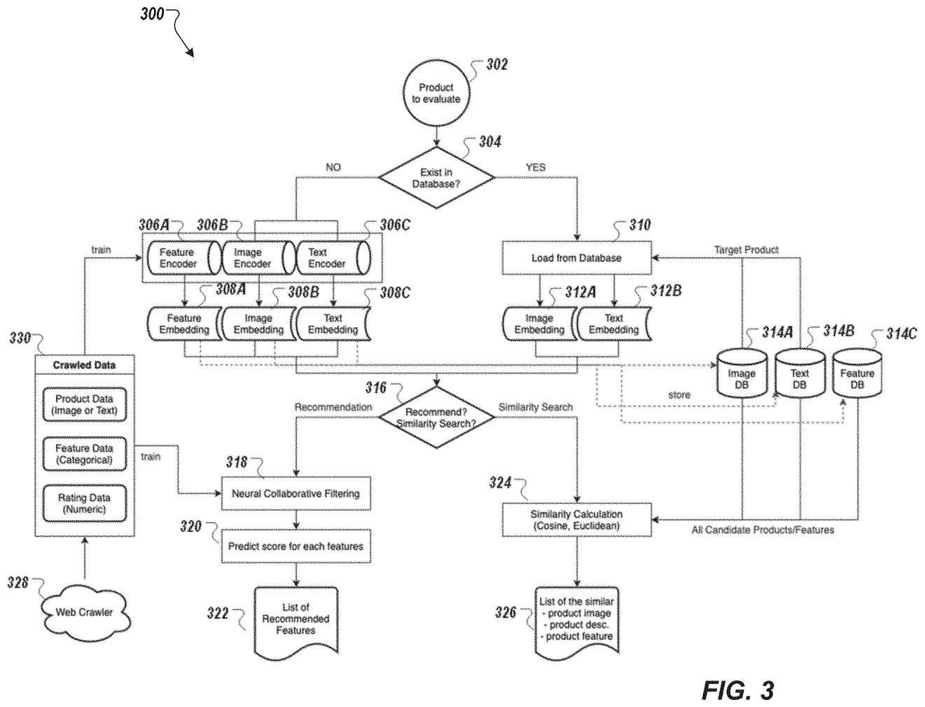

FIG. 3 depicts a representation of a recommendation workflow 300 in accordance with implementations of the present disclosure. As shown in the figure, the workflow 300 starts with a request 302 to evaluate a product. In some examples, the request includes a product profile (e.g., image, text description, and feature data) of the product. A determination is made on whether the product to be evaluated exists in a database 304.

If the product does not exist in the database, the product profile is processed with one or more encoders. For example, a feature encoder 306A can process the feature data to obtain a feature embedding 308A, such as a categorical vector, in a latent space; the image encoder 306B can process the image to obtain an image embedding 308B, such as an image vector, in the latent space; and the text encoder 306C can process the text description to obtain a text embedding 308C, such as a textual vector, in the latent space. The generated embedding information 308A, 308B, and 308C can be saved into the corresponding database, such as an image database 314A, a text database 314B, and a feature database 314C.

If the product exists in the database, the product embedding information is directly loaded from the database 310. For example, the image imbedding 312A and the text imbedding 312B are loaded from the corresponding databases.

The obtained embedding information can be used to make recommendations of candidate features for the product. In some implementations, the obtained embedding information can be used in similarity searches. A decision 316 is made on whether the request is for feature recommendation or similarity search.

If the request is for feature recommendation, the obtained embedding information is fed into a neural recommendation model that is based on neural collaborative filtering 318, which takes the embedding information as input, and predicts a score for each feature 320. The score of a feature can indicate the likelihood of the feature being preferred by customers. Based on the score of each feature, a list of recommended features 322 is generated. For example, the features with a score satisfying a threshold can be included in the list of recommended features.

If the request is for similarity search, the embedding information, such as the latent vectors, is used to calculate a similarity within products or features 324. The similarity can be determined based on at least one of a cosine similarity and a Euclidean distance. The similarity can be determined within the respective embedding type. For example, a similarity between a first product's image and a second product's image can be determined based on the respective image vectors. A similarity between the first product's text description and the second product's text description and the similarity between the first product's feature data and the second product's feature data can be determined in a similar manner. As a result, a list of similarities for product image, product description, and product feature can be obtained 326. The similarity analysis can be used to recommend similar products to customers. For example, based on the interaction history of a user with one or more products, the recommendation system can perform similarity analysis to identify and recommend products that are similar to the one or more products the user previously interacted with.

In some implementations, a web crawler 328 is a web crawling engine that can collect feedback data of features in different products from the Internet (e.g., from web pages available over the Internet). The crawled data 330 can include product data including images and text descriptions, feature data including categorical features of different products, and rating data including numeric data of customer ratings on the various features in various products. The crawled data 330 can be used to train the neural recommendation model (e.g., the neural collaborative filtering) 318. In addition, the crawled data 330 can be used to train the one or more encoders.

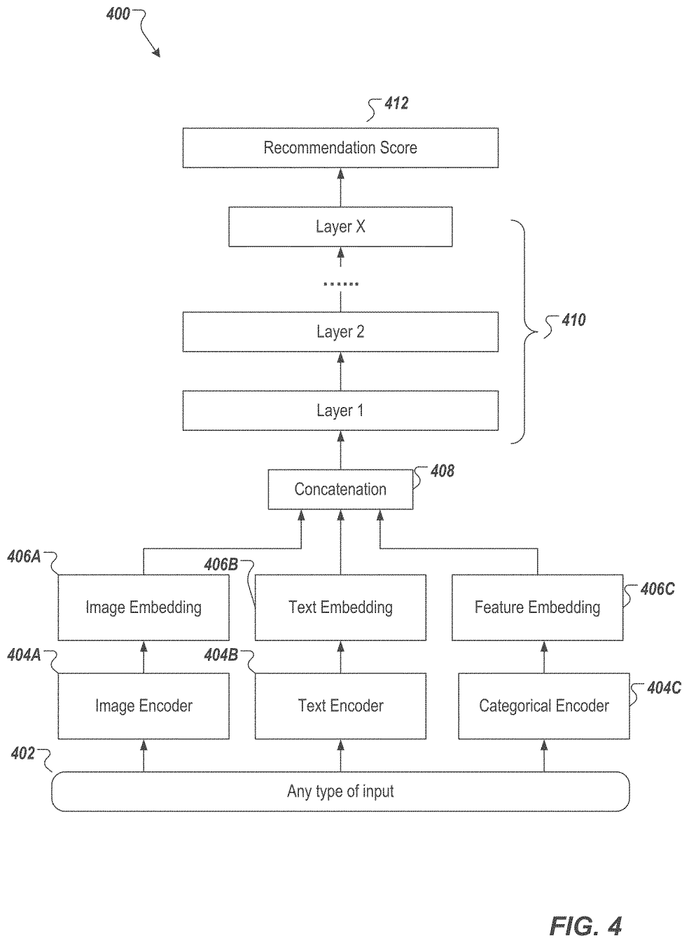

FIG. 4 depicts a representation of a recommendation structure 400 during the training process, in accordance with implementations of the present disclosure. As shown in the figure, the recommendation system can accept input 402, which can include any appropriate type of input either structured (e.g., categorical feature data) or unstructured (e.g., product image, text description). The received product profile information is processed with different encoders, each encoder corresponding to a data type of the received data. For example, the data type includes image data, textual data, and feature data. Specifically, an image encoder 404A encodes a product image to obtain an image embedding 406A, such as an image vector in latent space; a text encoder 404B encodes a text description to obtain a text embedding 406B, such as a textual vector in the latent space; a categorical encoder 404C encodes feature data to obtain feature embedding 406C, such as a categorical vector in the latent space. The image embedding 406A, the text embedding 406B, and the feature embedding 406C are concatenated to obtain a concatenation 408, which is a total latent vector.

The total latent vector is fed into a neural recommendation model (e.g., neural collaborative filtering model) including a set of layers 410 (e.g., although 3 layers are depicted, more layers can be included). The neural recommendation model outputs a recommendation score 412 for each feature, which indicates a likelihood of the feature being preferred. The neural recommendation model is trained based on at least one of the images, text descriptions and feature data of products.

In some implementations, the image encoder 404A includes a pre-trained model comprising Residual Networks (ResNet). The ResNet is trained using ImageNet dataset with 1000 object categories. The image encoder takes the image of the product as an input and generates a feature vector for the image utilizing the pre-trained model. The image feature vector, also referred to as image vector is generated after removing the fully connected layers from the pre-trained model.

In some implementations, the text encoder 404B includes a pre-trained Doc2Vec model. The text encoder is configured to convert one or more paragraphs of the text description into a numeric form using a shallow two-layer neural network. The neural network's learning objective is to predict the target word given the context words and a document ID. In the encoding process, the final weights corresponding to a document ID represent the latent vector for an input text.

In some implementations, the categorical encoder 404C includes a one-hot encoding algorithm. The categorical encoder can convert a category into a binary vector. The categorical encoder creates a binary column for each category. In some implementations, the categorical encoder can include a swivel (co-occurrence) encoding algorithm. The swivel encoding model generates feature embeddings from a feature co-occurrence matrix. The swivel encoding model performs approximate factorization of a matrix, so that multiplying the embeddings of row i and column j produces PMI (point-wise mutual information) for the pair (i, j).

The different encoders convert the different types of information regarding the product into vectors in a latent space using embeddings. An embedding is a way to represent discrete items, such as the image, text description, and feature data, as vectors of floating point numbers. Embeddings capture the semantics of the items by placing similar items close in the embedding space (latent space). In other words, the individual encoders capture and extract the semantics of the image, text description, and feature data by generating the corresponding numeric image vector, textual vector, and categorical vector in the latent space.

In some implementations, the generated image vector, textual vector, and categorical vector are stored in a database. Such vectors can be retrieved in later requests. For example, if a request including a product to be evaluated is received, and the product exists in the database, instead of encoding the product profile, the product's image vector, textual vector, and categorical vector can be retrieved directly from the database.

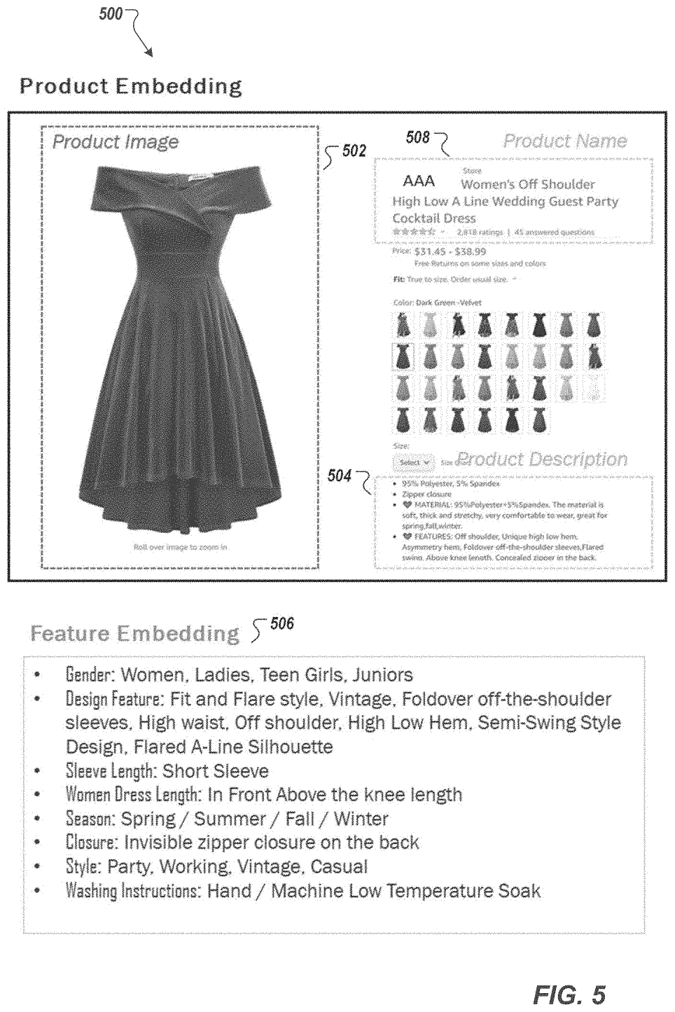

FIG. 5 depicts an example of a product profile 500 to be evaluated in accordance with implementations of the present disclosure. The product profile 500 can include product data of different types including a product image 502, a product text description 504, and feature data 506, that are associated with a product ID, such as the product name 508. The recommendation system of the present disclosure can take the different types of data and encode the data using different encoders, each encoder corresponding to a data type. Specifically, an image encoder can encode the product image 502 to obtain an image vector in a latent space that captures the semantics of the product image 502. A text encoder can encode the product text description 504 to obtain a textual vector in the latent space that captures the semantics of the product text description 504. Further, a categorical encoder can encode the feature data 506 to obtain a categorical vector in the latent space that captures the product features.

The obtained product embeddings, such as the image vector, textual vector, and categorical vector are used to represent the product, in this case, the product “AAA Women's Off Shoulder High Low A Line Wedding Guest Party Cocktail Dress.” Based on the product embeddings, the recommendation system of the present disclosure can generate recommended features for this product. For example, one of the recommended feature may be “long sleeve” and a score for the feature “long sleeve” that indicate how likely the customers would prefer the feature “long sleeve.” As shown in the example of FIG. 5, the existing feature of the product is “short sleeve.” As a result, the product development team can make changes based on the recommended feature “long sleeve” and the corresponding score. For example, if the score satisfies a certain threshold, the product development team may change the “short sleeve” to “long sleeve” in future production.

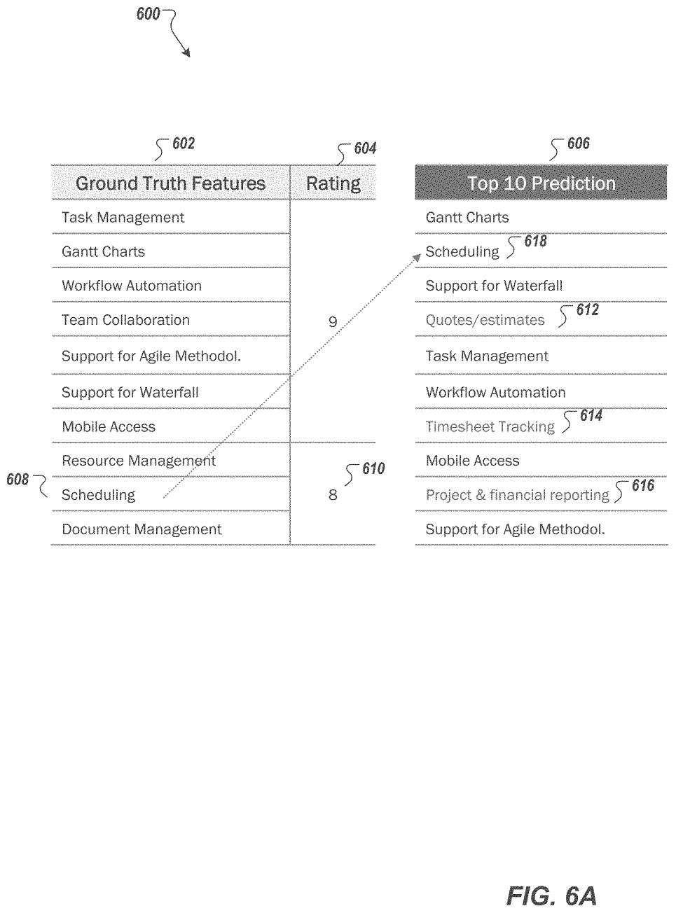

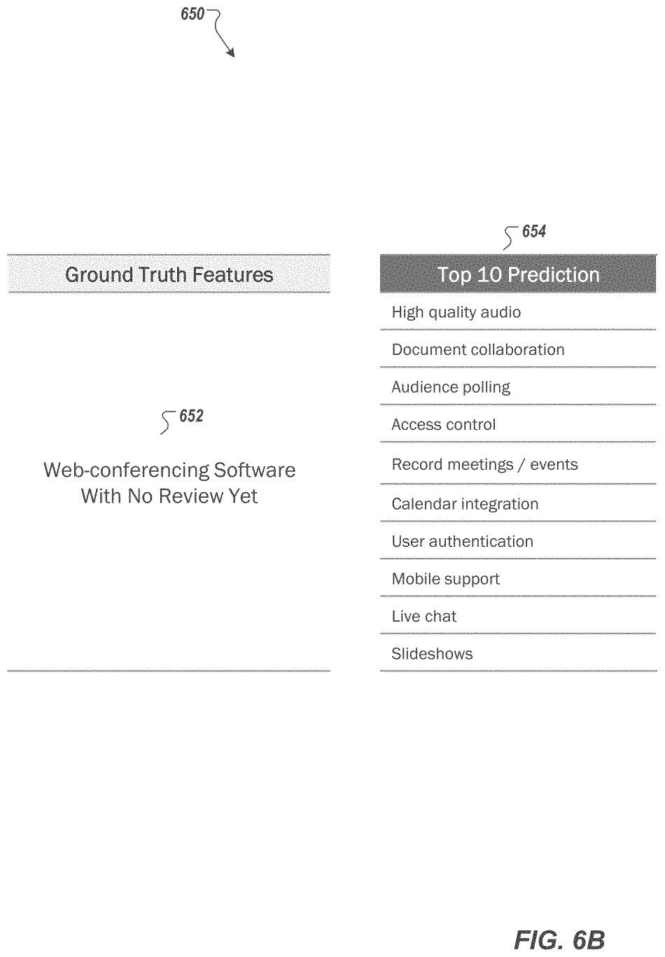

FIG. 6A depicts an example of recommendation results 600 for an existing product in accordance with implementations of the present disclosure. The existing product can be a software product in this example. The product can have a set of top ground truth features 602 with each feature being rated by customers. The ratings 604 can be collected using surveys or web crawling. As shown in FIG. 6A, the feature “scheduling” 608 is rated with a rating score “8” 610 based on the collected customer feedback. Using the recommendation system of the present disclosure, a new score is generated or predicted for each of a plurality of features. In this example, the top 10 prediction results 606 are shown. The top ten prediction results can be the top 10 candidate features ranked in a declining order based on the corresponding scores. Some of the recommended candidate features can be new features that are not included in the original top ground truth features, such as “quotes/estimates” 612, “timesheet tracking” 614, and “project & finance reporting” 616. Some of the recommended candidate features can be existing features with new scores. For example, the feature “scheduling” is assigned with a higher score and a higher priority based on the new recommendation results. In this example, the priority of feature “scheduling” is increased from the second lowest position into the second highest position 618. Therefore, the recommendation system of the present disclosure can help enterprises or product development teams organize the development process more efficiently, and invest resources in developing features with higher priorities first.

FIG. 6B depicts an example of recommendation results 650 for a new-to-market product in accordance with implementations of the present disclosure. In this example, the new-to-market product can be web-conference software having an empty review pane 652, as no reviews have yet been submitted. For the new-to-market product, there may be no product feature data available. In other words, the input to the recommendation system may only include the product image, or text description of the product, without any feature data. The recommendation system of the present disclosure can generate recommendations based only on the product descriptions, such as product image and text description. The recommendation results can be a set of candidate features that are most likely to be preferred by customers on the evaluated new-to-market product, and the corresponding scores of the recommended candidate features. A higher score for a feature indicates a higher probability of the feature being preferred by customers; the feature is assigned with a higher priority. In this example, the top 10 prediction results 654 are shown. These prediction results are ranked in a declining order based on the corresponding scores. Based on the recommended candidate features and the corresponding scores, the product development team can deliver the most desirable features along the respective priorities, which is helpful for business growth.

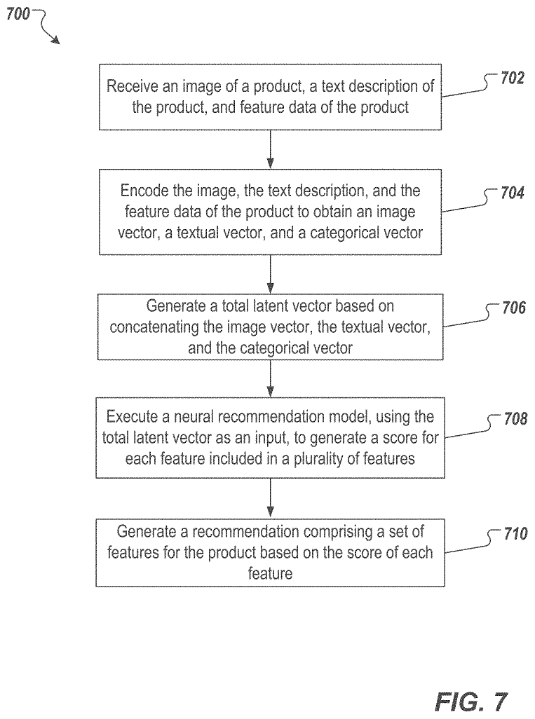

FIG. 7 depicts an example process 700 of predicting features for a product that can be executed in accordance with implementations of the present disclosure. The example process 700 can be implemented by the back-end system 108 shown in FIG. 1. In some examples, the example process 700 is provided using one or more computer-executable programs executed by one or more computing devices.

At step 702, a product profile is received, which includes an image of the product and a text description of the product. Techniques described herein can take any type of input simultaneously, such as image and text data of the product, to predict the desired features of the product.

At step 704, the image and the text description of the product are encoded to obtain an image vector and a textual vector in a latent space. The encoding process uses one or more encoders corresponding to a data type of the image and the text description. Specifically, the one or more encoders include an image encoder for encoding the image and a text encoder to encode the text description.

In some implementations, the generated image vector and textual vector are stored in a database. Such vectors can be retrieved in later requests. For example, if a request including a product to be evaluated is received, and the product exists in the database, instead of encoding the product profile, the product's image vector and textual vector can be retrieved directly from the database.

Furthermore, the techniques described herein can use the embedding of products and features that are stored in the database to perform further analysis such as computing a similarity within products or features. For example, the vectors saved in the database can be used to determine a similarity between a first product and a second product. For example, a first product can have a first image vector, a first textual vector, and a first categorical vector stored in the database; and the second product can have a second image vector, a second textual vector, and a second categorical vector stored in the database. A similarity can be determined within the respective embedding type. For example, the similarity between the first product's image and the second product's image can be determined using the first image vector and the second image vector. Further, the similarity between the first product's text description and the second product's text description and the similarity between the first product's feature data and the second product's feature data can be determined in a similar manner. The similarity can be represented as a similarity score. The similarity can be determined based on at least one of a cosine similarity and a Euclidean distance.

At step 706, a total latent vector is generated based on concatenating the image vector and the textual vector.

At step 708, a neural recommendation model is executed, using the total latent vector as an input, to generate a score for each feature included in a plurality of features.

The neural recommendation model is based on a neural collaborative filtering approach. In some implementations, the neural recommendation model comprises neural matric factorization model. The neural recommendation model is trained based on training data, which includes rating data of product features reviewed by users. The rating data are collected from the Internet by a web crawling engine. The training data can be a sparse user-item interaction matrix. For example, each row of matrix can represent a product feature, each column of the matrix can represent an item/product. The value at Column A and Row B can represent users' rating for Feature B in Product A. In some implementations, if a feature does not exist in a certain product, or there is no user rating/feedback for the feature in the product, the corresponding matrix value is set to be “NaN” (Not a Number). The matrix value representing the users' rating for a particular feature in a particular product can be a score, such as a number within a certain range. For example, the matrix value can be in a scale of 1 to 10, with “10” indicating the corresponding product-feature pair being the most useful/desirable for users, and “1” indicating the corresponding product-feature pair being the least useful/desirable to users. In some implementations, a rating value of the matrix is based on an average value of different rating values from different users who provide the feedback/ratings. In some implementations, other statistic representations, such as median, maximum, minimum, are used as the matrix values. In some implementations, the neural recommendation model is periodically updated based on newly collected web crawling data.

After the neural recommendation model is trained using the user-item interaction matrix, the trained neural recommendation model is configured to recommend a set of candidate features expected to be preferred by customers for one or more products. Such recommended candidate features can be provided to product development teams. In operation, the neural recommendation model can take the total latent vector as an input and output a score for each of a plurality of features. The plurality of features can be a collection of features extracted from data from a web crawling engine. For example, the plurality of features can be an exhaustive list of features for products of the same category based on the web crawling data.

For a particular product, the neural recommendation model can predict which features of the plurality of features should be candidate features to be included in a product. The predicated candidate features can be features already existing in the product, or new features that are not existing in the product but should be included in future production.

The output of the neural recommendation model can be a score for each feature included in the plurality of features. The score for a feature indicates the likelihood of the feature being desired/preferred by the users and the likelihood of being included as a feature of the product for product development. A high score may indicate that the feature is essential and should be considered for product development with a high probability.

At step 710, a recommendation including a set of candidate features for the product is generated based on the score of each feature. The set of candidate features can be features that are recommended to be included in product development. Such features can be the features that are most useful and desirable to customers. In some implementations, the set of candidate features are features whose scores satisfying a threshold.

In some implementations, the set of candidate features can be ranked based on the score of each feature. For example, the features with higher scores are ranked at the top. The highly ranked features can have higher scheduling priorities in the product development. Furthermore, the product development team can allocate more resources to the highly ranked features. As a result, such a feature suggestion framework can contribute to efficient product development and eventually the growth of the business.

Implementations of the present disclosure achieve one or more of the following example advantages. Implementations of the present disclosure can accept any appropriate type of input for recommendation, including image data, textual data, and categorical feature data. For example, implementations of the present disclosure use an encoder corresponding to each data type of input data to process the input data and obtain latent vectors in a latent space. By utilizing such input information, the recommendation system of the present disclosure captures rich semantics of product profiles to boost recommendation quality (e.g., particularly in the case of new-to-market products, for which little to no product feature data and feedback data is available). The recommendation system of the present disclosure can not only make recommendation on already existing features, but also identify and recommend features that are not already existing in products.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps reordered, added, or removed. Accordingly, other implementations are within the scope of the following claims.

What is claimed is:

1. A computer-implemented method for providing recommendations for product features using a machine learning (ML) model, the method comprising:
receiving a product profile comprising an image of a product and a text description of the product;
encoding the image and the text description of the product to obtain an image vector and a textual vector in a latent space;
wherein the encoding comprises encoding the image and the text description using one or more encoders, each encoder corresponding to a respective data type, data types comprising image data, textual data, and feature data;
concatenating the image vector and the textual vector to provide a total latent vector;
processing the total latent vector through a neural recommendation model to generate a score for each feature included in a plurality of features, wherein the score for a feature indicates a likelihood of the feature being included as a feature of the product for product development; and
generating a recommendation comprising a set of candidate features for the product based on the score of each feature.

2. The computer-implemented method of claim 1, further comprising determining a similarity between a first product and a second product based on i) a first image vector, a first textual vector, and a first categorical vector of the first product and ii) a second image vector, a second textual vector, and a second categorical vector of the second product.

3. The computer-implemented method of claim 2, further comprising determining the similarity based on at least one of a cosine similarity and a Euclidean distance.

4. The computer-implemented method of claim 1, further comprising ranking the set of candidate features for the product based on the score of each feature.

5. The computer-implemented method of claim 1, wherein the one or more encoders comprise an image encoder for encoding the image, a text encoder for encoding the text description, and a categorical encoder for encoding the feature data.

6. The computer-implemented method of claim 5, wherein the image encoder is a pre-trained model comprising Residual Networks (ResNet).

7. The computer-implemented method of claim 5, wherein the text encoder comprises a Doc2Vec model.

8. The computer-implemented method of claim 5, wherein the categorical encoder comprises a one-hot encoding algorithm.

9. The computer-implemented method of claim 1, wherein the neural recommendation model is trained and periodically updated based on data from a web crawling engine, wherein the neural recommendation model is trained based on at least one of images, text descriptions and feature data of products.

10. The computer-implemented method of claim 1, wherein the plurality of features are extracted from data from a web crawling engine.

11. One or more non-transitory computer-readable storage media coupled to one or more processors and having instructions stored thereon which, when executed by the one or more processors, cause the one or more processors to perform operations for providing recommendations from a computer-implemented recommendation system using a machine learning (ML) model, the operations comprising:
receiving a product profile comprising an image of a product and a text description of the product;
encoding the image and the text description of the product to obtain an image vector and a textual vector in a latent space;
wherein the encoding comprises encoding the image and the text description using one or more encoders, each encoder corresponding to a respective data type, data types comprising image data, textual data, and feature data;
concatenating the image vector and the textual vector to provide a total latent vector;
processing the total latent vector through a neural recommendation model to generate a score for each feature included in a plurality of features, wherein the score for a feature indicates a likelihood of the feature being included as a feature of the product for product development; and
generating a recommendation comprising a set of candidate features for the product based on the score of each feature.

12. The one or more non-transitory computer-readable storage media of claim 11, the operations further comprising determining a similarity between a first product and a second product based on i) a first image vector, a first textual vector, and a first categorical vector of the first product and ii) a second image vector, a second textual vector, and a second categorical vector of the second product.

13. The one or more non-transitory computer-readable storage media of claim 12, the operations further comprising determining the similarity based on at least one of a cosine similarity and a Euclidean distance.

14. The one or more non-transitory computer-readable storage media of claim 11, the operations further comprising ranking the set of candidate features for the product based on the score of each feature.

15. The one or more non-transitory computer-readable storage media of claim 11, wherein the one or more encoders comprise an image encoder for encoding the image, a text encoder for encoding the text description, and a categorical encoder for encoding the feature data.

16. The one or more non-transitory computer-readable storage media of claim 15, wherein the image encoder is a pre-trained model comprising Residual Networks (ResNet).

17. The one or more non-transitory computer-readable storage media of claim 15, wherein the text encoder comprises a Doc2Vec model.

18. The one or more non-transitory computer-readable storage media of claim 15, wherein the categorical encoder comprises a one-hot encoding algorithm.

19. The one or more non-transitory computer-readable storage media of claim 11, wherein the neural recommendation model is trained and periodically updated based on data from a web crawling engine, wherein the neural recommendation model is trained based on at least one of images, text descriptions and feature data of products.

20. The one or more non-transitory computer-readable storage media of claim 11, wherein the plurality of features are extracted from data from a web crawling engine.

21. A system, comprising:
one or more processors; and
a computer-readable storage device coupled to the one or more processors and having instructions stored thereon which, when executed by the one or more processors, cause the one or more processors to perform operations for providing recommendations from a computer-implemented recommendation system using a machine learning (ML) model, the operations comprising:
receiving a product profile comprising an image of a product and a text description of the product;
encoding the image and the text description of the product to obtain an image vector and a textual vector in a latent space;
wherein the encoding comprises encoding the image and the text description using one or more encoders, each encoder corresponding to a respective data type, data types comprising image data, textual data, and feature data;
concatenating the image vector and the textual vector to provide a total latent vector;
processing the total latent vector through a neural recommendation model to generate a score for each feature included in a plurality of features, wherein the score for a feature indicates a likelihood of the feature being included as a feature of the product for product development; and
generating a recommendation comprising a set of candidate features for the product based on the score of each feature.

22. The system of claim 21, the operations further comprising determining a similarity between a first product and a second product based on i) a first image vector, a first textual vector, and a first categorical vector of the first product and ii) a second image vector, a second textual vector, and a second categorical vector of the second product.

23. The system of claim 22, the operations further comprising determining the similarity based on at least one of a cosine similarity and a Euclidean distance.

24. The system of claim 21, the operations further comprising ranking the set of candidate features for the product based on the score of each feature.

25. The system of claim 21, wherein the one or more encoders comprise an image encoder for encoding the image, a text encoder for encoding the text description, and a categorical encoder for encoding the feature data.

26. The system of claim 25, wherein the image encoder is a pre-trained model comprising Residual Networks (ResNet).

27. The system of claim 25, wherein the text encoder comprises a Doc2Vec model.

28. The system of claim 25, wherein the categorical encoder comprises a one-hot encoding algorithm.

29. The system of claim 21, wherein the neural recommendation model is trained and periodically updated based on data from a web crawling engine, wherein the neural recommendation model is trained based on at least one of images, text descriptions and feature data of products.

30. The system of claim 21, wherein the plurality of features are extracted from data from a web crawling engine.
